(19) United States
(12) Patent Application Publication
(10) Pub. No.: US 2006/0132463 A1
(43) Pub. Date: Jun. 22, 2006

(54) Touch sensible display device

(76) Inventors: Joo-Hyung Lee, Gwacheon-si (KR); Young-Jun Choi, Suwon-si (KR); Kee-Han Uh, Yongin-si (KR)

Correspondence Address: CANTOR COLBURN, LLP, 55 GRIFFIN ROAD SOUTH, BLOOMFIELD, CT, 06002, US

(21) Appl. No.: 11/295,252

(22) Filed: Dec. 5, 2005

(30) Foreign Application Priority Data
Dec. 3, 2004 (KR) 10-2004-0100918

(51) Int. Cl. G09G 5/00

(52) U.S. Cl. 345/173

(57) ABSTRACT

A display device according to an embodiment of the present invention includes: a display panel including a plurality of image scanning lines and a plurality of sensor scanning lines; a plurality of display units coupled to the image scanning lines; a plurality of photo sensing units coupled to the sensor scanning lines and outputting sensor output signals in response to an amount of external light; an image scanning driver applying image scanning signals to the image scanning lines; and an sensor scanning driver applying sensor scanning signals to the sensor scanning lines, wherein the image scanning driver and the sensor scanning driver are disposed at the same side of the display panel.

### BACKGROUND OF THE INVENTION

(a) Field of the Invention

The present invention relates to a display device and in particular, a touch sensible display device.

(b) Description of Related Art

A liquid crystal display (LCD) includes a pair of panels provided with pixel electrodes and a common electrode and a liquid crystal layer with dielectric anisotropy interposed between the panels. The pixel electrodes are arranged in a matrix and connected to switching elements such as thin film transistors (TFTs) such that they receive image data voltages row by row. The common electrode covers entire surface of one of the two panels and it is supplied with a common voltage. A pixel electrode and corresponding portions of the common electrode, and corresponding portions of the liquid crystal layer form a liquid crystal capacitor that as well as a switching element connected thereto is a basic element of a pixel.

An LCD generates electric fields by applying voltages to pixel electrodes and a common electrode and varies the strength of the electric fields to adjust the transmittance of light passing through a liquid crystal layer, thereby displaying images.

Recently, an LCD incorporating photosensors has been developed. The photosensors senses the change of incident light caused by a touch of a finger or a stylus and provides electrical signals corresponding thereto for the LCD. The LCD processes the electrical signals from the photosensors and outputs the processed signals to an external device. The external device determines whether and where a touch exists based on the processed electrical signals and may return image signals to the LCD, which are generated based on the information.

An LCD including a photosensor includes an image scanning driver and a sensor scanning driver for turning on and off switching transistors in the photosensors and switching transistors of the pixels. The scanning drivers include shift registers including a plurality of stages and are incorporated in the panels.

The shift register may occupy considerable areas and may consume large power depending on the arrangement of the shift register. Furthermore, the sensing signals generated from the photosensors may be easily affected by the common voltage or the data voltages.

### SUMMARY OF THE INVENTION

A display device according to an embodiment of the present invention includes: a display panel including a plurality of image scanning lines and a plurality of sensor scanning lines; a plurality of display units coupled to the image scanning lines; a plurality of photo sensing units coupled to the sensor scanning lines and outputting sensor output signals in response to an amount of external light; an image scanning driver applying image scanning signals to the image scanning lines; and an sensor scanning driver applying sensor scanning signals to the sensor scanning lines, wherein the image scanning driver and the sensor scanning driver are disposed at the same side of the display panel.

The sensor scanning driver may receive the image scanning signals from the image scanning driver and may output the image scanning signals as the sensor scanning signals according to at least one frame signal.

The sensor scanning driver may include a plurality of switching transistors connected between the image scanning driver and the sensor scanning lines. The switching transistors may include first and second switching transistors coupled to the same sensor scanning line and alternately turning on every frame.

The sensor scanning driver may output odd image scanning signals from the image scanning driver as the sensor scanning signals in odd frames, and may output even image scanning signals from the image scanning driver as the sensor scanning signals in even frames.

The switching transistors may include first, second, third, and fourth switching transistors coupled to the same sensor scanning line and sequentially turning on in a period of four frames.

The image scanning driver may include first and second image scanning circuits disposed at opposite sides of the display panel and alternately connected to the image scanning lines. The sensor scanning driver may include first and second sensor scanning circuits disposed at opposite sides of the display panel.

The sensor scanning lines may include first sensor scanning lines coupled to the first sensor scanning circuit and second sensor scanning lines coupled to the second sensor scanning circuit, and the first and the second sensor scanning lines may be alternately arranged on the display panel.

The first and the second sensor scanning circuits may be coupled to the same scanning signal lines.

The first sensor scanning circuit may output first image scanning signals from the first image scanning circuit and outputs the first image scanning signals as the sensor scanning signals according to the at least one frame signal, and the second sensor scanning circuit may output second image scanning signals from the second image scanning circuit and outputs the second image scanning signals as the sensor scanning signals according to the at least one frame signal.

The first sensor scanning circuit may include first switching transistors connected between the first image scanning circuit and the sensor scanning lines, and the second sensor scanning circuit may include second switching transistors connected between the second image scanning circuit and the sensor scanning lines.

The first sensor scanning circuit may output the first image scanning signals from the first image scanning circuit as the sensor scanning signals in odd frames, and the second sensor scanning circuit may output the second image scanning signals from the second image scanning circuit as the sensor scanning signals in even frames.

The sensor scanning signals may be applied to the sensor scanning lines at different timings in different frames.

A common voltage applied to the display units may swing between a high level and a low level, and the sensor output signals may be outputted when the common voltage is a predetermined one of the high level and the low level.

The display device may perform frame inversion and row inversion.

The image scanning driver and the sensor scanning driver may be integrated into the display panel.

The image scanning driver or the sensor scanning driver may include a shift register including a plurality of stages.

At least two of the sensor scanning lines are connected to each other to be coupled to the sensor scanning driver.

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel of an LCD according to an embodiment of the present invention;

FIG. 3 is a schematic diagram of an LCD according to an embodiment of the present invention;

FIG. 4 is a block diagram of an LC panel assembly, an image scanning driver, and a sensor scanning driver according to an embodiment of the present invention;

FIGS. 5A and 5B are timing diagrams of input signals and output signals of the image scanning driver and the sensor scanning driver shown in FIG. 4 for odd frames and even frames, respectively;

FIG. 6 is a block diagram of an LC panel assembly, an image scanning driver, and a sensor scanning driver according to another embodiment of the present invention;

FIGS. 7A and 7B are timing diagrams of input signals and output signals of the image scanning driver and the sensor scanning driver shown in FIG. 6 for odd frames and even frames, respectively;

FIG. 8 is a block diagram of an LC panel assembly, an image scanning driver, and a sensor scanning driver according to another embodiment of the present invention;

FIGS. 9A and 9B are timing diagrams of input signals and output signals of the image scanning driver and the sensor scanning driver shown in FIG. 8 for odd frames and even frames, respectively;

FIG. 10 is a block diagram of an LC panel assembly, an image scanning driver, and a sensor scanning driver according to an embodiment of the present invention

FIGS. 11A and 11B are timing diagrams of input signals and output signals of the image scanning driver and the sensor scanning driver shown in FIG. 10 for odd frames and even frames, respectively;

FIG. 12 is a block diagram of an LC panel assembly, an image scanning driver, and a sensor scanning driver according to another embodiment of the present invention;

FIGS. 13A and 13B are timing diagrams of input signals and output signals of the image scanning driver and the sensor scanning driver shown in FIG. 12 for odd frames and even frames, respectively; and

FIG. 14 is a block diagram of an LC panel assembly, an image scanning driver, and a sensor scanning driver according to another embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

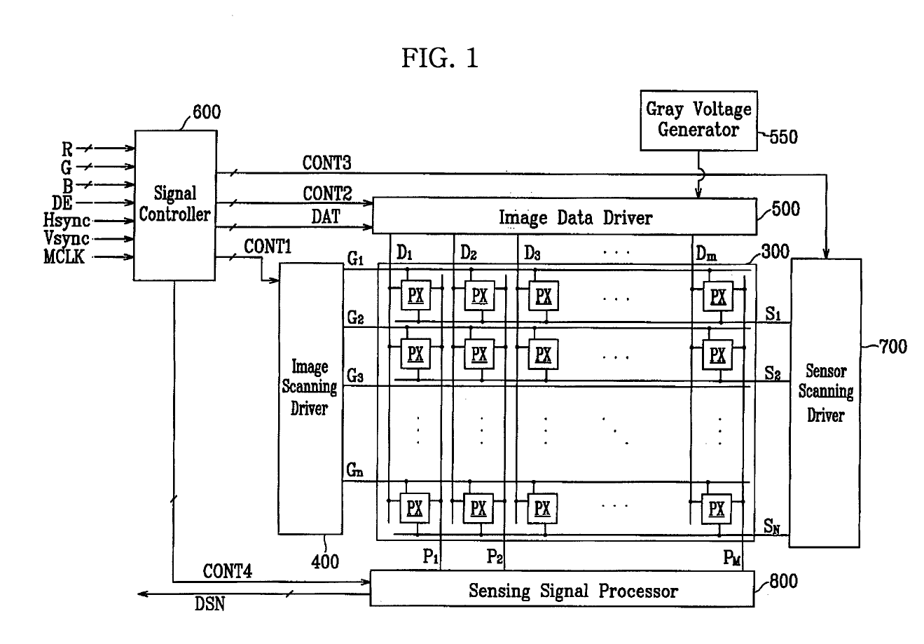

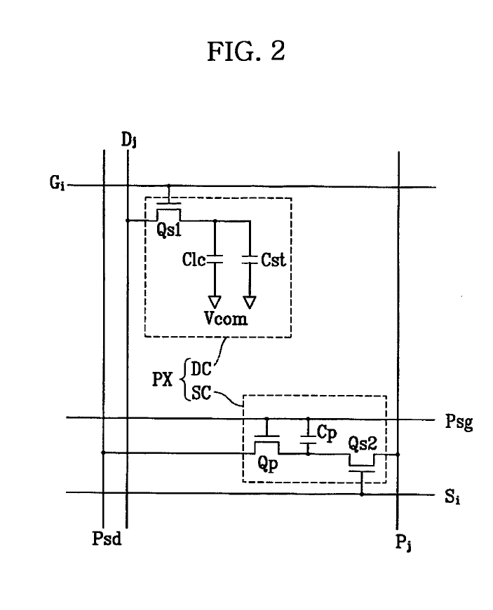

A liquid crystal display as an example of a display device according to an embodiment of the present invention now will be described in detail with reference to FIGS. 1 and 2.

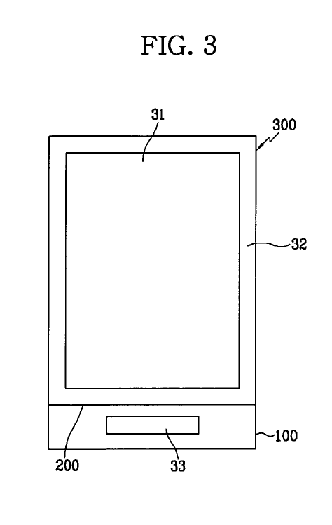

FIG. 1 is a block diagram of an LCD according to an embodiment of the present invention, FIG. 2 is an equivalent circuit diagram of a pixel of an LCD according to an embodiment of the present invention, and FIG. 3 is a schematic diagram of an LCD according to an embodiment of the present invention.

Referring to FIG. 1, an LCD according to an embodiment includes a liquid crystal (LC) panel assembly 300, an image scanning driver 400, an image data driver 500, a sensor scanning driver 700, and a sensing signal processor 800 that are coupled with the panel assembly 300, a gray voltage generator 550 coupled to the image data driver 500, and a signal controller 600 controlling the above elements.

Referring to FIGS. 1-3, the panel assembly 300 includes a plurality of display signal lines G₁-Gₙ and D₁-Dₘ, a plurality of sensor signal lines S₁-S_{N}, P₁-P_{M}, Psg and Psd, and a plurality of pixels PX. The pixels PX are connected to the display signal lines G₁-Gₙ and D₁-Dₘ and the sensor signal lines S₁-S_{N}, P₁-P_{M}, Psg and Psd and arranged substantially in a matrix.

The display signal lines include a plurality of image scanning lines G₁-Gₙ transmitting image scanning signals and a plurality of image data lines D₁-Dₘ transmitting image data signals.

The sensor signal lines include a plurality of a plurality of sensor scanning lines S₁-S_{N} transmitting sensor scanning signals, a plurality of sensor data lines P₁-P_{M} transmitting sensor data signals, a plurality of control voltage lines Psg transmitting a sensor control voltage, and a plurality of input voltage lines Psd transmitting a sensor input voltage.

The image scanning lines G₁-Gₙ and the sensor scanning lines S₁-S_{N} extend substantially in a row direction and substantially parallel to each other, while the image data lines D₁-Dₘ and the sensor data lines P₁-P_{M} extend substantially in a column direction and substantially parallel to each other.

Referring to FIGS. 2 and 3, each pixel PX, for example, a pixel PX in the i-th row (i=1, 2, . . . , n) and the j-th column (j=1, 2, . . . , m) includes a display circuit DC connected to display signal lines Gᵢ and Dⱼ and a photo sensing circuit SC connected to sensor signal lines Sᵢ, Pⱼ, Psg and Psd. However, only a given number of the pixels PX may include the sensing circuits SC. In other words, the concentration of the sensing circuits SC may be varied and thus the number N of the sensor scanning lines S₁-S_{N} and the number M of the sensor data lines P₁-P_{M} may be varied.

The sensing circuits SC may be separated from the pixels PX and may be provided between the pixels PX or in a separately prepared area.

The display circuit DC includes a switching element Qs1 connected to an image scanning line Gᵢ and an image data line Dⱼ, and a LC capacitor Clc and a storage capacitor Cst that are connected to the switching element Qs1. The storage capacitor Cst may be omitted.

The switching element Qs1 has three terminals, i.e., a control terminal connected to the image scanning line Gᵢ, an input terminal connected to the image data line Dⱼ, and an output terminal connected to the LC capacitor Clc and the storage capacitor Cst.

The LC capacitor Clc includes a pair of terminals and a liquid crystal layer (not shown) interposed therebetween and it is connected between the switching element Qs1 and a common voltage Vcom. The two terminals of the LC capacitor Clc may be disposed on a lower panel 100 and an upper panel 200 of the panel assembly 300. One of the two terminals is often referred to as a pixel electrode disposed on the lower panel 100, and the other of the two terminals is often referred to as a common electrode disposed on the upper panel 200. The common electrode covers an entire area of the upper panel 200 and is supplied with a common voltage Vcom.

The storage capacitor Cst assists the LC capacitor Clc and it is connected between the switching element Qs1 and a predetermined voltage such as the common voltage Vcom. The storage capacitor Cst may include the pixel electrode and a separate signal line, which is provided on the lower panel 100 and overlaps the pixel electrode via an insulator. Alternatively, the storage capacitor Cst includes the pixel electrode and an adjacent image scanning line called a previous image scanning line, which overlaps the pixel electrode via an insulator.

For a color display, each pixel PX uniquely represents one of primary colors (i.e., spatial division) or each pixel PX sequentially represents the primary colors in turn (i.e., temporal division) such that a spatial or temporal sum of the primary colors is recognized as a desired color. An example of a set of the primary colors includes red, green, and blue colors. In an example of the spatial division, each pixel PX includes a color filter representing one of the primary colors in an area facing the pixel electrode 190.

The photo sensing circuit SC shown in FIG. 2 includes a photo sensing element Qp connected to a control voltage line Psg and an input voltage line Psd, a sensor capacitor Cp connected to the photo sensing element Qp, and a switching element Qs2 connected to a sensor scanning line Sᵢ, the photo sensing element Qp, and a sensor data line Pⱼ.

The photo sensing element Qp has three terminals, i.e., a control terminal connected to the control voltage line Psg to be biased by the sensor control voltage, an input terminal connected to the input voltage line Psd to be biased by the sensor input voltage, and an output terminal connected to the switching element Qs2. The photo sensing element Qp includes a photoelectric material that generates a photocurrent upon receipt of light. An example of the photo sensing element Qp is a thin film transistor having an amorphous silicon or polysilicon channel that can generate a photocurrent. The sensor control voltage applied to the control terminal of the photo sensing element Qp is sufficiently low or sufficiently high to keep the photo sensing element Qp in an off state without incident light. The sensor input voltage applied to the input terminal of the photo sensing element Qp is sufficiently high or sufficiently low to keep the photocurrent flowing in a direction. The photocurrent flows toward the switching element Qs2 by the sensor input voltage and it also flows into the sensor capacitor Cp to charge the sensor capacitor Cp.

The sensor capacitor Cp is connected between the control terminal and the output terminal of the photo sensing element Qp. The sensor capacitor Cp stores electrical charges output from the photo sensing element Qp to maintain a predetermine voltage. The sensor capacitor Cp may be omitted.

The switching element Qs2 also has three terminals, i.e., a control terminal connected to the sensor scanning line Sᵢ, an input terminal connected to the output terminal of the photo sensing element Qp, and an output terminal connected to the sensor data line Pⱼ. The switching element Qs2 outputs a sensor output signal to the sensor data line Pⱼ in response to the sensor scanning signal from the sensor scanning line Sᵢ. The sensor output signal is a sensing current from the photo sensing element Qp. However, the sensor output signal may be a voltage stored in the sensor capacitor Cp.

The switching elements Qs1 and Qs2 and the photo sensing element Qp may include amorphous silicon or polysilicon thin film transistors (TFTs).

In structural view shown in FIG. 3, the LC panel assembly 300 includes a light blocking member 32 referred to as a black matrix defining a display area 31. Most portions of the pixels PX and the signal lines G₁-Gₙ, D₁-Dₘ, S₁-S_{N}, P₁-P_{M}, Psg and Psd are disposed in the display area 31. The upper panel 200 is smaller than the lower panel 100 to expose some area of the lower panel 100 where the data lines D₁-Dₘ extend to be connected to the image data driver 500. The scanning lines G₁-Gₙ and S₁-S_{N} extend to the area covered with the light blocking member 32 to be connected to the image scanning driver 400 and the sensor scanning driver 700, respectively.

One or more polarizers (not shown) are provided at the panel assembly 300.

Referring to FIG. 1 again, the gray voltage generator 550 generates two sets of gray voltages related to a transmittance of the pixels. The gray voltages in a first set have a positive polarity with respect to the common voltage Vcom, while the gray voltages in a second set have a negative polarity with respect to the common voltage Vcom.

The image scanning driver 400 is connected to the image scanning lines G₁-Gₙ of the panel assembly 300 and synthesizes a gate-on voltage and a gate-off voltage to generate the image scanning signals for application to the image scanning lines G₁-Gₙ.

The image data driver 500 is connected to the image data lines D₁-Dₘ of the panel assembly 300 and applies image data signals selected from the gray voltages to the image data lines D₁-Dₘ.

The sensor scanning driver 700 is connected to the sensor scanning lines S₁-S_{N} of the panel assembly 300 and synthesizes a gate-on voltage and a gate-off voltage to generate the sensor scanning signals for application to the sensor scanning lines S₁-S_{N}.

Each of the image scanning driver 400 and the sensor scanning driver 700 includes a shift register including a plurality of stages connected in series. In FIG. 3, the image scanning driver 400 and the sensor scanning driver 700 are disposed in an area covered with the light blocking member 32 and integrated into the lower panel 100 along with the switching elements Qs1 and Qs2 and the photo sensing element Qp. However, the image scanning driver 400 and the sensor scanning driver 700 may include at least one integrated circuit (IC) chip mounted on the lower panel 100.

The sensing signal processor 800 is connected to the sensor data lines P₁-P_{M} of the display panel 300 and receives and processes the sensor data signals from the sensor data lines P₁-P_{M}. One sensor data signal carried by one sensor data line P₁-P_{M} at a time may include one sensor output signal from one switching elements Qs2 or may include at least two sensor output signals outputted from at least two switching elements Qs2.

The signal controller 600 controls the image scanning driver 400, the image data driver 500, the sensor scanning driver 700, and the sensing signal processor 800, etc.

The gray voltage generator 550, the image data driver 500, the sensing signal processor 800, and the signal controller 600 are integrated into an IC chip 33 mounted on the panel assembly 300 as shown in FIG. 3. However, at least one of the gray voltage generator 550, the image data driver 500, the sensing signal processor 800, and the signal controller 600 may be implemented as a separate IC chip mounted in a chip on film (COF) type.

Now, the operation of the above-described LCD will be described in detail.

The signal controller 600 is supplied with input image signals R, G and B and input control signals for controlling the display thereof from an external graphics controller (not shown). The input control signals include a vertical synchronization signal Vsync, a horizontal synchronization signal Hsync, a main clock MCLK, and a data enable signal DE.

On the basis of the input control signals and the input image signals R, G and B, the signal controller 600 generates image scanning control signals CONT1, image data control signals CONT2, sensor scanning control signals CONT3, and sensor data control signals CONT4, and it processes the image signals R, G and B suitable for the operation of the display panel 300. The signal controller 600 sends the scanning control signals CONT1 to the image scanning driver 400, the processed image signals DAT and the data control signals CONT2 to the image data driver 500, the sensor scanning control signals CONT3 to the sensor scanning driver 700, and the sensor data control signals CONT4 to the sensing signal processor 800.

The image scanning control signals CONT1 include an image scanning start signal STV for instructing to start image scanning and at least one clock signal for controlling the output time of the gate-on voltage. The image scanning control signals CONT1 may include an output enable signal OE for defining the duration of the gate-on voltage.

The image data control signals CONT2 include a horizontal synchronization start signal STH for informing of start of image data transmission for a group of pixels PX, a load signal LOAD for instructing to apply the image data signals to the image data lines D₁-Dₘ and a data clock signal HCLK. The image data control signal CONT2 may further include an inversion signal RVS for reversing the polarity of the image data signals (with respect to the common voltage Vcom).

Responsive to the image data control signals CONT2 from the signal controller 600, the image data driver 500 receives a packet of the digital image signals DAT for the group of pixels PX from the signal controller 600, converts the digital image signals DAT into analog image data signals selected from the gray voltages, and applies the analog image data signals to the image data lines D₁-Dₘ.

The image scanning driver 400 applies the gate-on voltage to an image scanning line G₁-Gₙ in response to the image scanning control signals CONT1 from the signal controller 600, thereby turning on the switching transistors Qs1 connected thereto. The image data signals applied to the image data lines D₁-Dₘ are then supplied to the display circuit DC of the pixels PX through the activated switching transistors Qs1.

The difference between the voltage of an image data signal and the common voltage Vcom is represented as a voltage across the LC capacitor Clc, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into the light transmittance to display images.

By repeating this procedure by a unit of a horizontal period (also referred to as “1H” and equal to one period of the horizontal synchronization signal Hsync and the data enable signal DE), all image scanning lines G₁-Gₙ are sequentially supplied with the gate-on voltage, thereby applying the image data signals to all pixels PX to display an image for a frame.

When the next frame starts after one frame finishes, the inversion control signal RVS applied to the image data driver 500 is controlled such that the polarity of the image data signals is reversed (which is referred to as “frame inversion”). The inversion control signal RVS may be also controlled such that the polarity of the image data signals flowing in a data line are periodically reversed during one frame (for example, row inversion and dot inversion), or the polarity of the image data signals in one packet are reversed (for example, column inversion and dot inversion).

In the meantime, the sensor scanning driver 700 applies the gate-on voltage to the sensor scanning lines S₁-S_{N} to turn on the switching elements Qs2 connected thereto in response to the sensing control signals CONT3. Then, the switching elements Qs2 output sensor output signals to the sensor data lines P₁-P_{M} to form sensor data signals, and the sensor data signals are inputted into the sensing signal processor 800.

The sensing signal processor 800 reads sensor data signals from the sensor data lines P₁-P_{M} in response to the sensor data control signals CONT4 and the sensing signal processor 800 processes, for example, amplifies and filters the read sensor data signals. The sensing signal processor 800 converts the analog sensor data signals into touch information signals DSN and outputs the touch information signals DSN to an external device. The external device appropriately processes the touch information signals DSN to determine whether and where a touch exists and sends image signals generated based on information about the touch to the LCD.

The sensing operation is performed independent from the display operation, and thus the sensing operation and the display operation are not affected by each other. The sensing operation for one row has a period equal to 1H or more depending on the concentration of the photo sensing units SC. The sensing operation may be performed every frame, but it may be performed in a period of several frames.

Now, an LC panel assembly, an image scanning driver, and a sensor scanning driver according to embodiments of the present invention will be described in detail. The description will focus on the differences from the above-described embodiment.

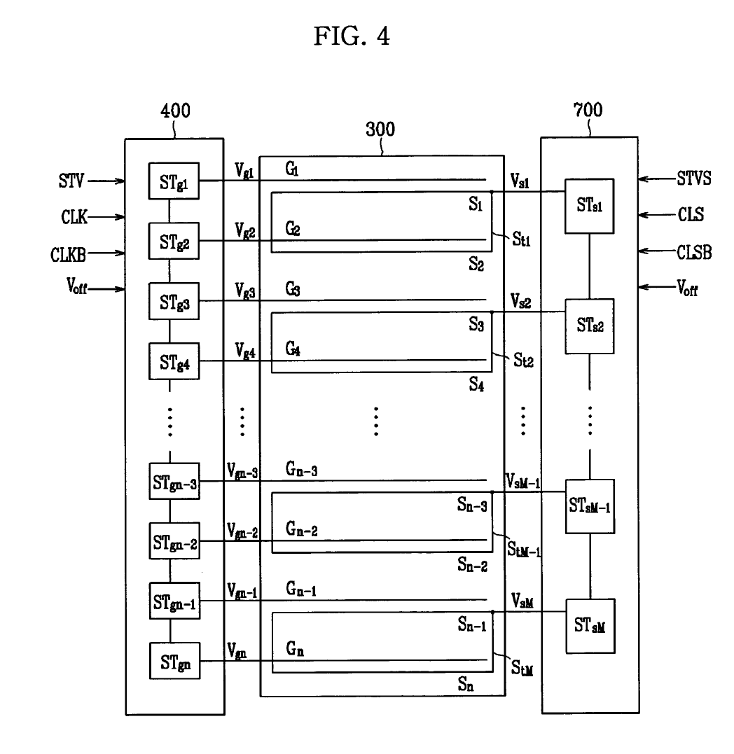

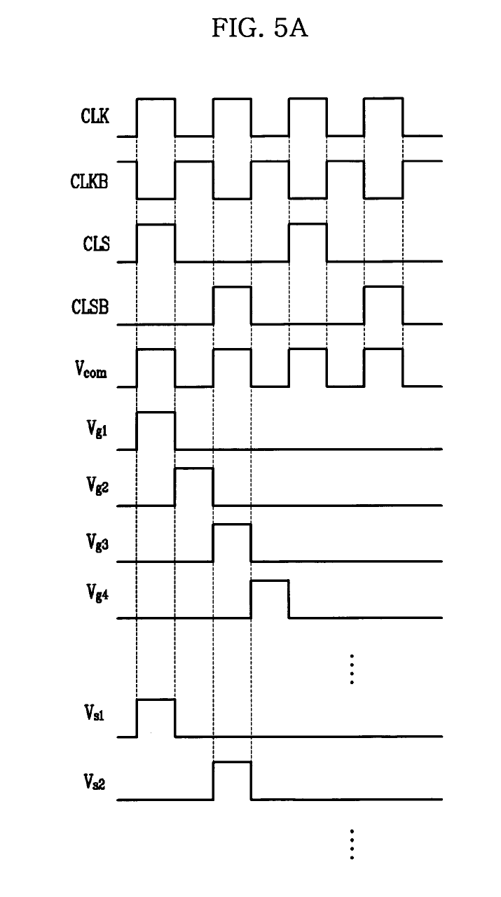

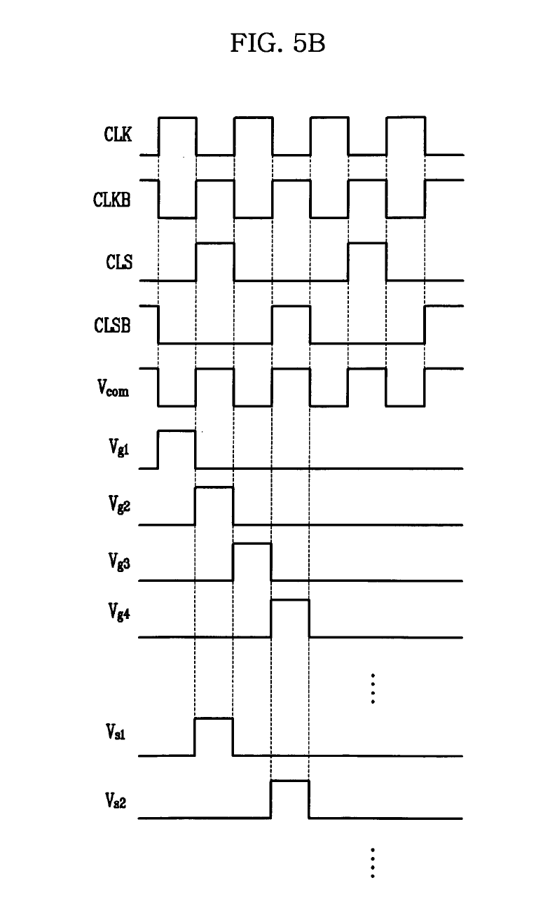

First, an LC panel assembly, an image scanning driver, and a sensor scanning driver according to an embodiment of the present invention will be described with reference to FIGS. 4, 5A and 5B.

FIG. 4 is a block diagram of an LC panel assembly, an image scanning driver, and a sensor scanning driver according to an embodiment of the present invention, and FIGS. 5A and 5B are timing diagrams of input signals and output signals of the image scanning driver and the sensor scanning driver shown in FIG. 4 for odd frames and even frames, respectively.

Referring to FIG. 4, an LCD according to this embodiment includes an LC panel assembly 300, an image scanning driver 400, and a sensor scanning driver 700.

The LC panel assembly 300 includes a plurality of image scanning lines G₁-Gₙ, a plurality of sensor scanning lines S₁-Sₙ, and a plurality of pixels.

The image scanning lines G₁-Gₙ are coupled to the image scanning driver 400 and transmit image scanning signals Vg₁-Vgₙ from the image scanning driver 400 to the display units in the pixels.

The sensor scanning lines S₁-Sₙ are connected in pairs to form a plurality of scanning lines Sₜ₁-S_{tM}. The scanning lines Sₜ₁-S_{tM} are coupled to the sensor scanning driver 700 and transmit sensor scanning signals Vs₁-Vs_{M} from the sensor scanning driver 700 to the sensing units in the pixels. Here, M is equal to n/2, which means that the longitudinal resolution of the display units is twice the longitudinal resolution of the sensing units.

In this configuration, two sensor scanning lines S₁-Sₙ are simultaneously supplied with the same sensor scanning signal such that sensor output signals of two sensing units coupled to the same sensor data signal P₁-Pₘ overlap each other. The sensor data signals formed by overlapping the sensor output signals may reduce the deviations of the characteristics of the photo sensing units SC and may have a doubled signal-to-noise ratio, thereby improving the precision of the sensing operation.

Three or more sensor scanning lines S₁-Sₙ may be connected to each other, or odd or even sensor scanning lines S₁-Sₙ may be connected to the sensor scanning driver 700.

The image scanning driver 400 includes a plurality of stages STg₁-STgₙ connected in series. The stages STg₁-STgₙ are connected to respective image scanning lines G₁-Gₙ, and receives an image scanning start signal STV, a pair of clock signals CLK and CLKB, and a gate-off voltage Voff. The stages STg₁-STgₙ output the image scanning signals Vg₁-Vgₙ having a period of 1H to the image scanning lines G₁-Gₙ based on the image scanning start signal STV, the clock signals CLK and CLKB, and the gate-off voltage Voff.

The sensor scanning driver 700 includes a plurality of stages STs₁-STs_{M} connected in series. The stages STs₁-STs_{M} are connected to respective scanning lines Sₜ₁-S_{tM}, receives a sensor scanning start signal STVS, a pair of clock signals CLS and CLSB, and the gate-off voltage Voff. The stages STs₁-STs_{M} output the sensor scanning signals Vs₁-Vs_{M} having a period of 2H to the scanning lines Sₜ₁-S_{tM} based on the sensor scanning start signal STVS, the clock signals CLS and CLSB, and the gate-off voltage Voff.

Referring to FIGS. 5A and 5B, the clock signals CLK and CLKB have a period of 2H, a duty ratio equal to about 50%, and a phase difference of about 180 degrees. The clock signals CLS and CLSB have a period of 4H, a duty ratio equal to about 25%, and a phase difference of about 180 degrees. The clock signals CLK, CLKB, CLS and CLSB may have a high level equal to the gate-on voltage and a low level equal to the gate-off voltage Voff for turning on the switching elements Qs1 and Qs2, and the high level of the clock signals CLK, CLKB, CLS and CLSB remain for 1H.

The LCD performs the row inversion and the frame inversion. Accordingly, the common voltage Vcom swings and has a phase different by 180 degrees between odd and even frames as shown in FIGS. 5A and 5B. Since the sensor data signals are affected by the voltage level of the common voltage Vcom, it is preferable that the sensor data signals are read when the common voltage Vcom has a predetermined level, i.e., the high voltage level or the low voltage level. When the clock signals CLS and CLSB have a phase difference of 90 degrees between odd and even frames, the sensor scanning signals Vs₁-Vs_{M} is equal to the gate-on voltage Von only when the common voltage Vcom is in the high level. Alternately, the sensor scanning signals Vs₁-Vs_{M} is equal to the gate-on voltage Von only when the common voltage Vcom is in the low level.

Although the image scanning driver 400 and the sensor scanning driver 700 are shown to be disposed opposite each other on the LC panel assembly 300, they may be disposed at the same side of the LC panel assembly 300.

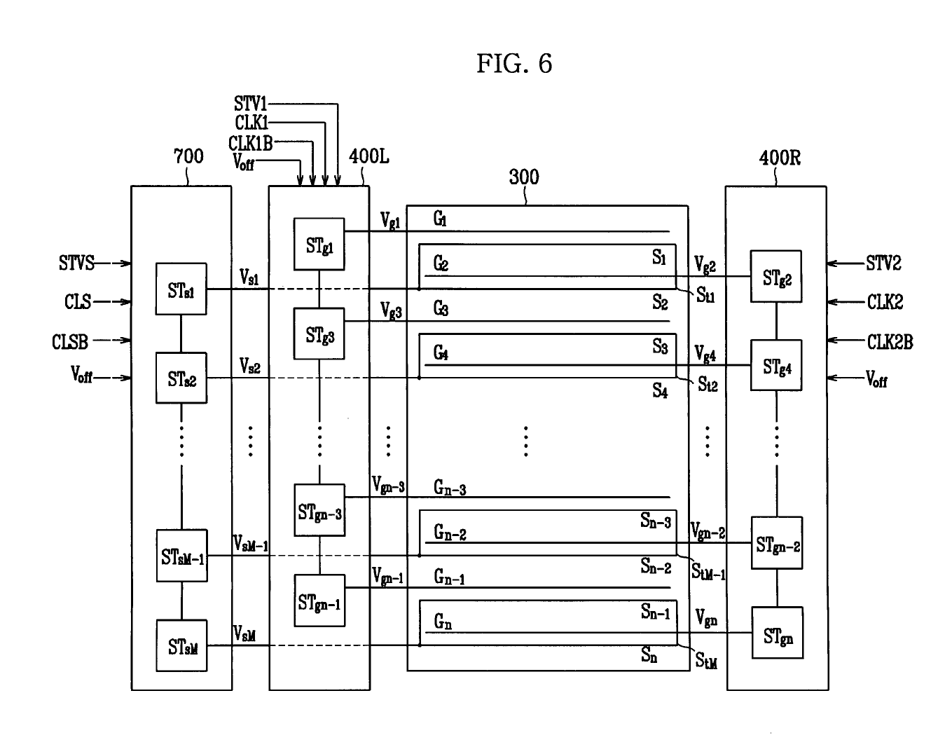

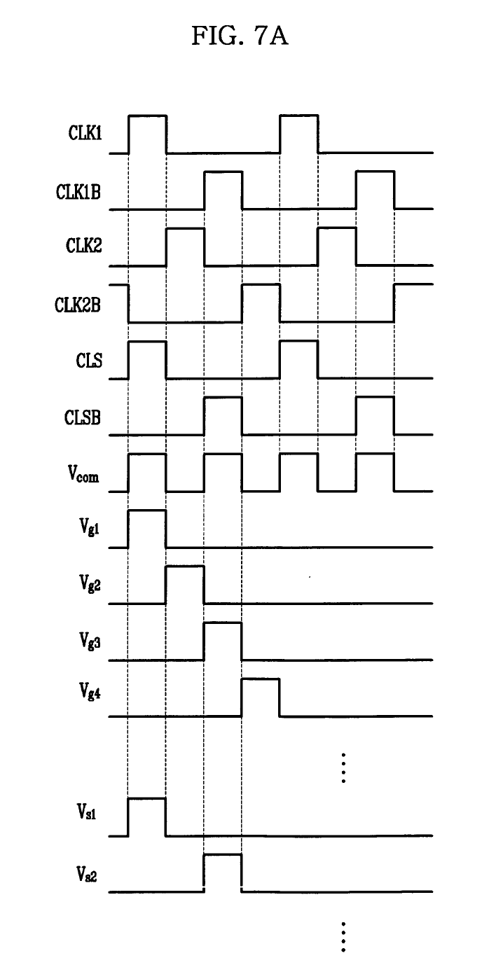

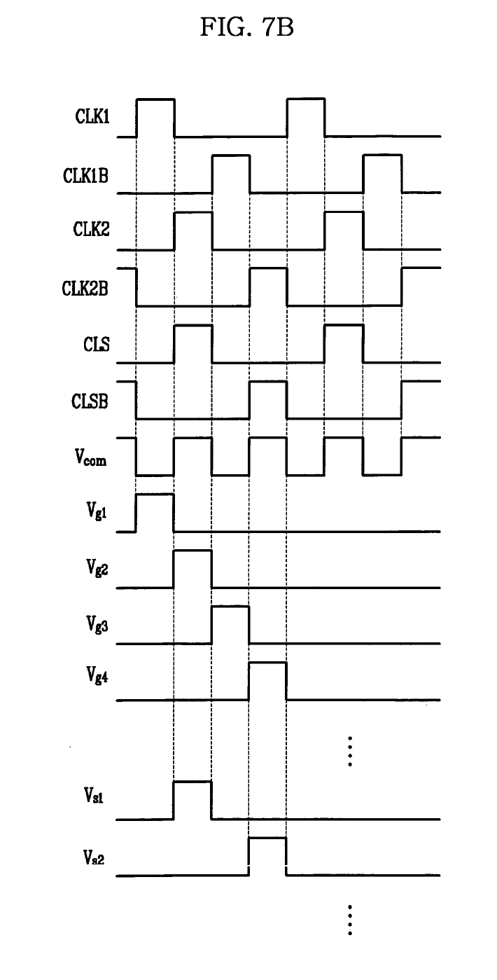

Next, an LC panel assembly, an image scanning driver, and a sensor scanning driver according to another embodiment of the present invention will be described with reference to FIGS. 6, 7A and 7B.

FIG. 6 is a block diagram of an LC panel assembly, an image scanning driver, and a sensor scanning driver according to another embodiment of the present invention, and FIGS. 7A and 7B are timing diagrams of input signals and output signals of the image scanning driver and the sensor scanning driver shown in FIG. 6 for odd frames and even frames, respectively.

Referring to FIG. 6, an LCD according to this embodiment includes an LC panel assembly 300, a pair of left and right image scanning drivers 400L and 400R, and a sensor scanning driver 700. Hereinafter, reference numeral 400 will denote both the left and the right image scanning drivers 400L and 400R.

The LC panel assembly 300 includes a plurality of image scanning lines G₁-Gₙ, a plurality of sensor scanning lines S₁-Sₙ, and a plurality of pixels.

Odd image scanning lines (G₁, G₃, . . . , Gₙ₋₁) are coupled to the left image scanning driver 400L and transmit odd image scanning signals (Vg₁, Vg₃, . . . , Vgₙ₋₁) from the left image scanning driver 400L to the display units of the pixels. The even image scanning lines (G₂, G₄, . . . , Gₙ) coupled to the right image scanning driver 400R and transmit even image scanning signals (Vg₂, Vg₄, . . . , Vgₙ) from the right image scanning driver 400R to the display units of the pixels.

The left image scanning driver 400L and the right image scanning driver 400R are disposed at left and right sides of the LC panel assembly 300, respectively.

The left image scanning driver 400L includes a plurality of stages (STg₁, STg₃, . . . , STgₙ₋₁) connected in series. The stages (STg₁, STg₃, . . . , STgₙ₋₁) are coupled to respective odd image scanning lines (G₁, G₃, . . . , Gₙ₋₁) and receive a first image scanning start signal STV1, a pair of clock signals CLK1, CLK1B, and the gate-off voltage Voff. The stages (STg₁, STg₃, . . . , STgₙ₋₁) output the odd image scanning signals (Vg₁, Vg₃, . . . , Vgₙ₋₁) having a period of 2H based on the first image scanning start signal STV1, the clock signals CLK1, CLK1B, and the gate-off voltage Voff.

The right image scanning driver 400R includes a plurality of stages (STg₂, STg₄, . . . , STgₙ) connected in series. The stages (STg₂, STg₄, . . . , STgₙ) are coupled to respective even image scanning lines (G₂, G₄, . . . , Gₙ) and receive a second image scanning start signal STV2, a pair of clock signals CLK2 and CLK2B, and the gate-off voltage Voff. The stages (STg₂, STg₄, . . . , STgₙ) output the even image scanning signals (Vg₂, Vg₄, . . . , Vgₙ) having a period of 2H based on the second image scanning start signal STV2, the clock signals CLK2 and CLK2B, and the gate-off voltage Voff. The high levels of the even image scanning signals (Vg₂, Vg₄, . . . , Vgₙ) and the odd image scanning signals (Vg₁, Vg₃, . . . , Vgₙ₋₁) alternate with each other and remain a period of 1H.

The sensor scanning driver 700 has substantially the same configuration with that shown in FIG. 4 and the detailed description thereof will be omitted. The position of the sensor scanning driver 700, which is illustrated at a left side of the LC panel assembly 300, may be the right side of the panel assembly 300.

Referring to FIGS. 7A and 7B, the clock signals CLK1 and CLK1B have a period of 4H, a duty ratio equal to about 25%, and a phase difference of about 180 degrees. Similarly, the clock signals CLK2 and CLK2B have a period of 4H, a duty ratio equal to about 25%, and a phase difference of about 180 degrees. The clock signals CLK1 and CLK2 have phases different by 90 degrees, and the clock signals CLK1B and CLK2B also have phases different by 90 degrees. The clock signals CLK1, CLK1B, CLK2 and CLK2B may have a high level equal to the gate-on voltage and a low level equal to the gate-off voltage Voff for turning on the switching elements Qs1 and Qs2, and the high level of the clock signals CLK1, CLK1B, CLK2 and CLK2B remain for 1H. The image scanning signals (Vg₁-Vgₙ) shown in FIGS. 7A and 7B are generated based on the clock signals CLK1, CLK1B, CLK2 and CLK2B.

The image scanning driver 400 shown in FIG. 6 consumes less power than that shown in FIG. 4.

It is assumed that the power consumptions of the image scanning driver 400 and the sensor scanning driver 700 shown in FIG. 4 are denoted by Pd and Ps, respectively. Since the sensor scanning lines S₁-Sₙ are connected in pairs, the capacitance of the sensor scanning lines S₁-Sₙ is twice the capacitance of the image scanning lines G₁-Gₙ. The frequency of the clock signals CLS and CLSB is a half of the frequency of the clock signals CLK and CLKB. Since the power consumption is proportional to the capacitance and the frequency, the power consumption Ps of the sensor scanning driver 700 is equal to the power consumption Pd of the image scanning driver 400.

However, since the image scanning driver 400 according to this embodiment is divided into left and right halves, the charging capacity of the image scanning drivers 400L and 400R shown in FIG. 6 is a half of the charging capacity of the image scanning driver 400 shown in FIG. 4, and the frequency of the clock signals CLK1, CLK1B, CLK2 and CLK2B shown in FIGS. 7A and 7B is a half of the clock signals shown in FIGS. 5A and 5B. Accordingly, the power consumption of the image scanning driver 400 shown in FIG. 6 is a half of the power consumption of the image scanning driver 400 shown in FIG. 4. As a result, the power consumption of the image scanning driver 400 and the sensor scanning driver 700 shown in FIG. 6 is about 75% of that shown in FIG. 4.

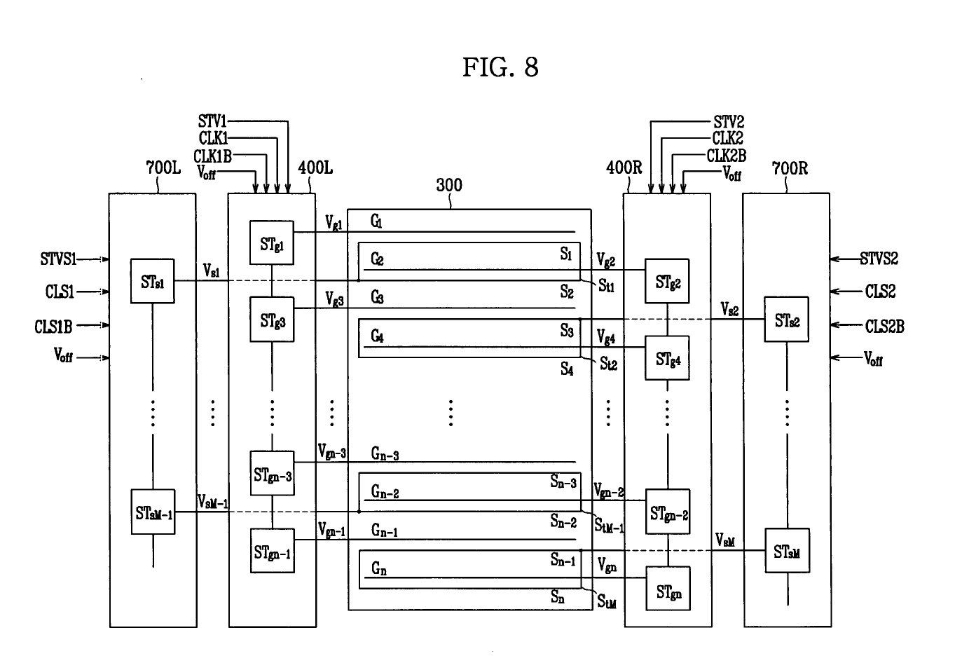

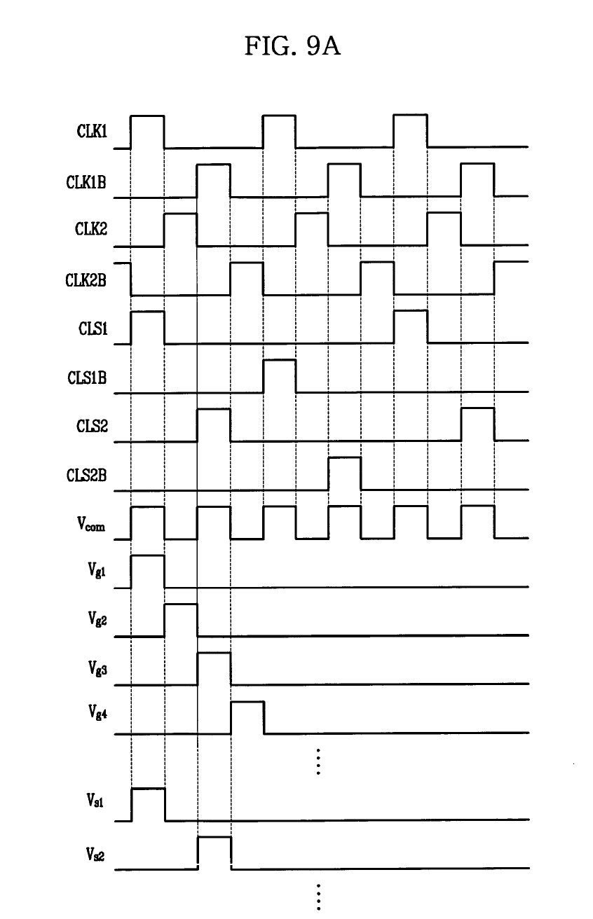

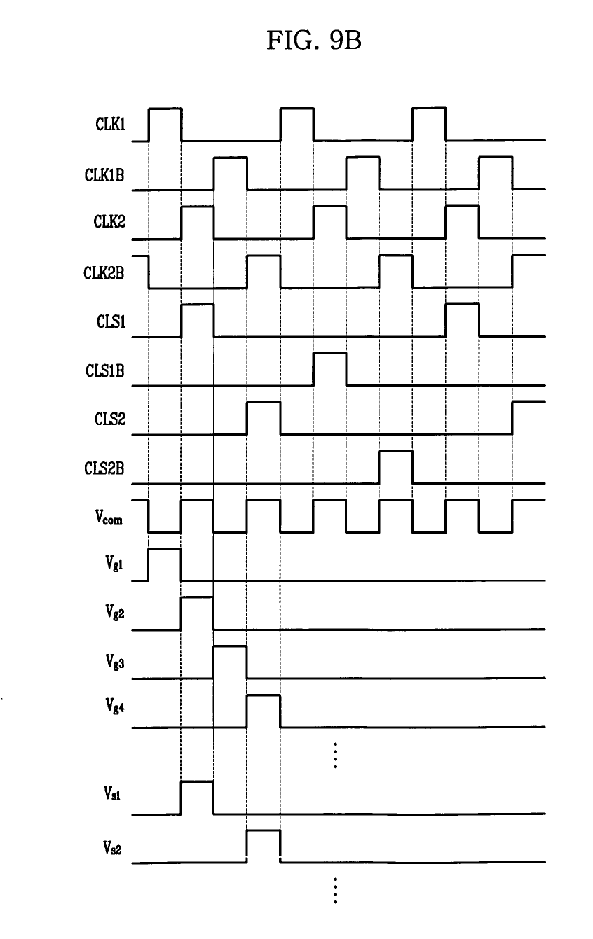

Next, an LC panel assembly, an image scanning driver, and a sensor scanning driver according to another embodiment of the present invention will be described with reference to FIGS. 8, 9A and 9B.

FIG. 8 is a block diagram of an LC panel assembly, an image scanning driver, and a sensor scanning driver according to another embodiment of the present invention, and FIGS. 9A and 9B are timing diagrams of input signals and output signals of the image scanning driver and the sensor scanning driver shown in FIG. 8 for odd frames and even frames, respectively.

Referring to FIG. 8, an LCD according to this embodiment includes an LC panel assembly 300, a pair of left and right image scanning drivers 400L and 400R, and a pair of left and right sensor scanning drivers 700L and 700R. Hereinafter, reference numeral 700 will denote both the left and the right sensor scanning drivers 700L and 700R.

The LC panel assembly 300 includes a plurality of image scanning lines G₁-Gₙ, a plurality of sensor scanning lines S₁-Sₙ, and a plurality of pixels.

The sensor scanning lines S₁-Sₙ are connected in pairs to form a plurality of scanning lines Sₜ₁-S_{tM}. Odd scanning lines (Sₜ₁, Sₜ₃, . . . , S_{tM-1}) are coupled to the left sensor scanning driver 700L and transmit odd sensor scanning signals (Vs₁, Vs₃, . . . , Vs_{M-1}) from the left sensor scanning driver 700L to the sensing units of the pixels. Even scanning lines (Sₜ₂, Sₜ₄, . . . , S_{tM}) are coupled to the right sensor scanning driver 700R and transmit even sensor scanning signals (Vs₂, Vs₄, . . . , Vs_{M}) from the right sensor scanning driver 700R to the sensing units of the pixels.

The left sensor scanning driver 700L and the right sensor scanning driver 700R are disposed at left and right sides of the LC panel assembly 300, respectively.

The left sensor scanning driver 700L includes a plurality of stages (STs₁, STs₃, . . . , STs_{M-1}) connected in series. The stages (STs₁, STs₃, . . . , STs_{M-1}) receive first sensor scanning signals STVS1, a pair of clock signals CLS1 and CS1B, and the gate-off voltage Voff and output the odd sensor scanning signals (Vs₁, Vs₃, . . . , Vs_{M-1}) having a period of 4H based thereon.

The right sensor scanning driver 700R includes a plurality of stages (STs₂, STs₄, . . . , STs_{M}) connected in series. The stages (STs₂, STs₄, . . . , STs_{M}) receive second sensor scanning start signals STVS2, a pair of clock signals CLS2 and CLS2B, and the gate-off voltage Voff and output the even sensor scanning signals Vs₂, Vs₄, . . . , Vs_{M}) having a period of 4H based thereon. The high levels of the even sensor scanning signals (Vs₂, Vs₄, . . . , Vs_{M}) and the odd sensor image scanning signals (Vs₁, Vs₃, . . . , Vs_{M-1}) alternate with each other and remains a period of 2H.

The image scanning driver 400 has substantially the same configuration with that shown in FIG. 6 and the detailed description thereof will be omitted.

Referring to FIGS. 9A and 9B, the clock signals CLS1 and CLS1B have a period of 8H, a duty ratio equal to about 12.5%, and a phase difference of about 180 degrees. Similarly, the clock signals CLS2 and CLS2B have a period of 8H, a duty ratio equal to about 12.5%, and a phase difference of about 180 degrees. The clock signals CLS1 and CLS2 have phases different by 90 degrees, and the clock signals CLS1B and CLS2B also have phases different by 90 degrees. The clock signals CLS1, CLS1B, CLS2 and CLS2B may have a high level equal to the gate-on voltage and a low level equal to the gate-off voltage Voff for turning on the switching elements Qs2, and the high level of the clock signals CLS1, CLS1B, CLS2 and CLS2B remain for 1H. In addition, the clock signals CLS1, CLSB1, CLS2 and CLSB2 have phase differences of 45 degrees between odd and even frames. Therefore, the sensor scanning signals Vs₁-Vs_{M} become equal the gate-on voltage Von only when the common voltage Vcom is in the high level. The sensor scanning signals Vs₁-Vs_{M} shown in FIGS. 9A and 9B are generated based on the clock signals CLS1, CLS1B, CLS2 and CLS2B.

The image scanning driver 400 shown in FIG. 8 consumes less power than that shown in FIG. 6. Since the sensor scanning driver 700 according to this embodiment is divided into halves, the charging capacity of the sensor scanning drivers 700L and 700R shown in FIG. 8 is a half of the charging capacity of the sensor scanning driver 700 shown in FIG. 6, and the frequency of the clock signals CLS1, CLS1B, CLS2 and CLS2B shown in FIGS. 9A and 9B is a half of the clock signals shown in FIGS. 7A and 7B. Accordingly, the power consumption of the image scanning driver 400 shown in FIG. 8 is a half of the power consumption of the image scanning driver 400 shown in FIG. 6. As a result, the power consumption of the image scanning driver 400 and the sensor scanning driver 700 shown in FIG. 6 is about 50% of that shown in FIG. 4.

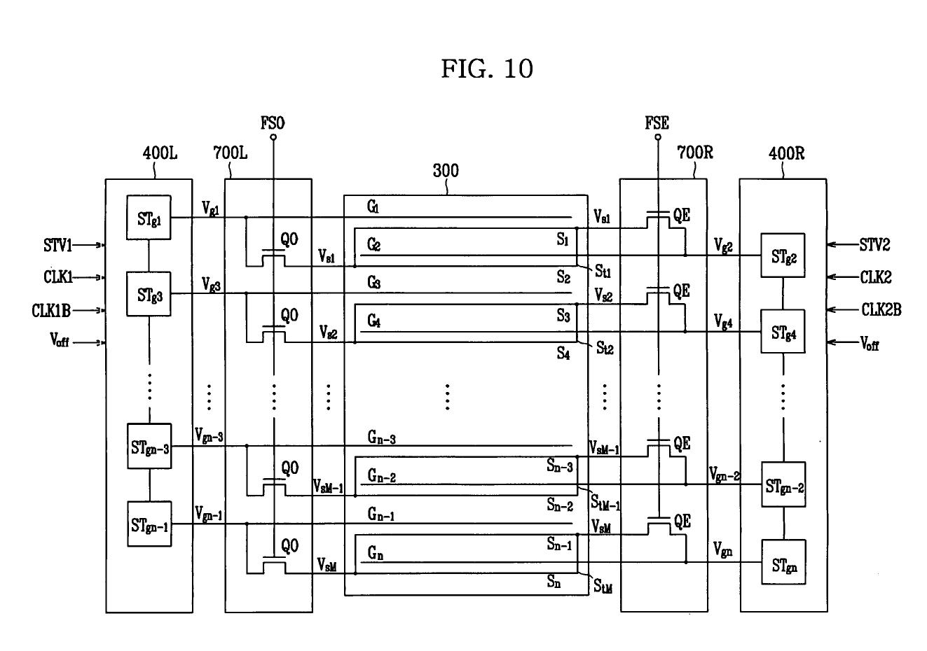

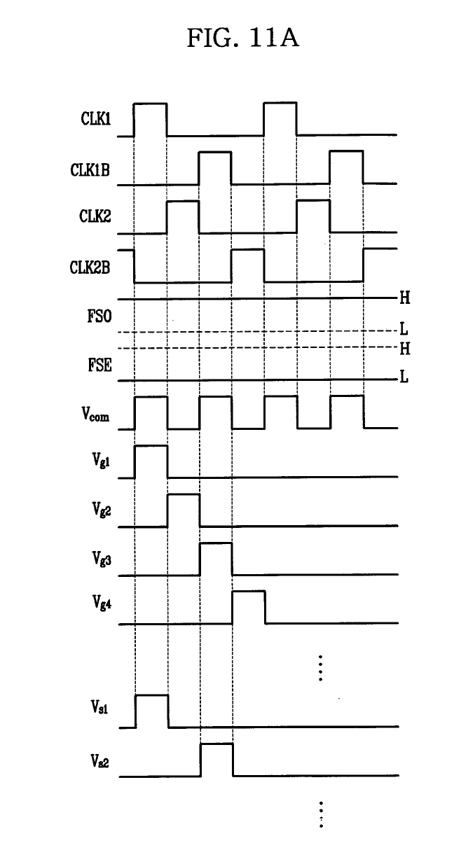

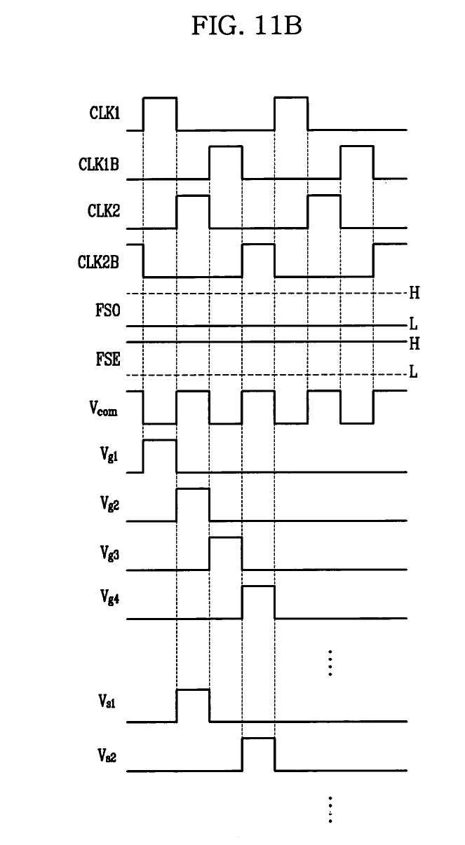

Next, an LC panel assembly, an image scanning driver, and a sensor scanning driver according to another embodiment of the present invention will be described with reference to FIGS. 10, 11A and 11B.

FIG. 10 is a block diagram of an LC panel assembly, an image scanning driver, and a sensor scanning driver according to an embodiment of the present invention, and FIGS. 11A and 11B are timing diagrams of input signals and output signals of the image scanning driver and the sensor scanning driver shown in FIG. 10 for odd frames and even frames, respectively.

Referring to FIG. 10, an LCD according to this embodiment includes an LC panel assembly 300, a pair of left and right image scanning drivers 400L and 400R, and a pair of left and right sensor scanning drivers 700L and 700R.

The LC panel assembly 300 includes a plurality of image scanning lines G₁-Gₙ, a plurality of sensor scanning lines S₁-Sₙ, and a plurality of pixels.

The sensor scanning lines S₁-Sₙ, are connected in pairs to form a plurality of scanning lines Sₜ₁-S_{tM}. The scanning lines Sₜ₁-S_{tM} are coupled to the left and the right sensor scanning drivers 700L and 700R and transmit sensor scanning signals Vs₁-Vs_{M} from the sensor scanning drivers 700L and 700R to the sensing units of the pixels.

The left sensor scanning driver 700L includes a plurality of switching transistors QO. Each of the switching transistors QO has an input terminal coupled to a stage (STg₁, STg₃, . . . , STgₙ₋₁) of the left image scanning driver 400L, a control terminal connected to an odd frame signal FSO, and an output terminal connected to a scanning line Sₜ₁-S_{tM}.

In the odd frames, the left sensor scanning driver 700L is supplied with the odd frame signal FSO and outputs odd image scanning signals (Vg₁, Vg₃, . . . , Vgₙ₋₁) as the sensor scanning signals Vs₁-Vs_{M}.

The right sensor scanning driver 700R includes a plurality of switching transistors QE. Each of the switching transistors QE has an input terminal coupled to a stage (STg₂, STg₄, . . . , STgₙ) of the right image scanning driver 400R, a control terminal connected to an even frame signal FSE, and an output terminal coupled to a scanning line Sₜ₁-S_{tM}.

In even frames, the right sensor scanning driver 700R receives the even frame signal FSE and outputs even image scanning signals (Vg₂, Vg₄, . . . , Vgₙ) as sensor scanning signals Vs₁-Vs_{M}.

Referring to FIGS. 11A and 11B, the odd frame signal FSO has a high level H in odd frames and has a low level L in even frames. On the contrary, the odd frame signal FSO has a low level L in odd frames and has a high level H in even frames. The sensor scanning signals Vs₁-Vs_{M} becomes equal to the gate-on voltage Von every 2H according to the frame signals FSO and FSE only when the common voltage Vcom is in a high level.

The image scanning driver 400 has substantially the same configuration with those shown in FIGS. 6 and 8 and the detailed description thereof will be omitted. However, it is noted that since each of the stages STg₁-STgₙ drives two scanning lines G₁-Gₙ and S₁-Sₙ in average, the size of charging and discharging transistors in the stages STg₁-STgₙ becomes large.

Although the power consumption of the image scanning driver 400 shown in FIG. 10 is twice that shown in FIG. 8, the total power consumption of the device shown in FIG. 10 is almost equal to that shown in FIG. 8 since the sensor scanning driver 700 hardly consumes power.

In the meantime, the size of the sensor scanning driver 700 is decreased to reduce the occupying area and the number of the input signals is decreased to reduce the size of the chip 33.

The left and right image scanning drivers 400L and 400R and the left and right sensor scanning drivers 700L and 700R may be disposed at the same side of the LC panel assembly 300.

When the longitudinal resolution of the sensing units is a quarter of the longitudinal resolution of the display units, either of the odd scanning lines and the even scanning lines and the switching transistors QO or QE connected thereto may be omitted.

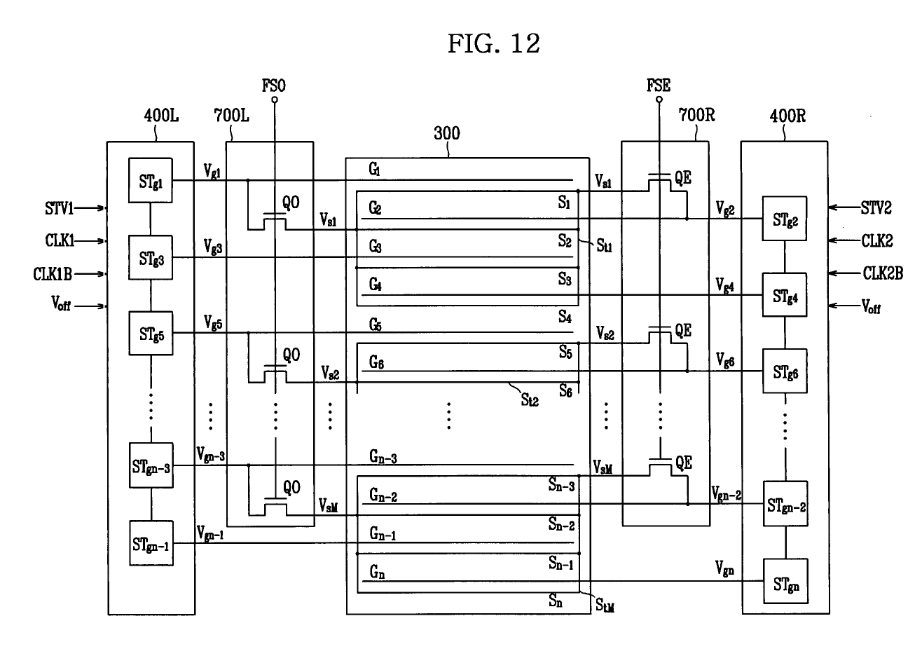

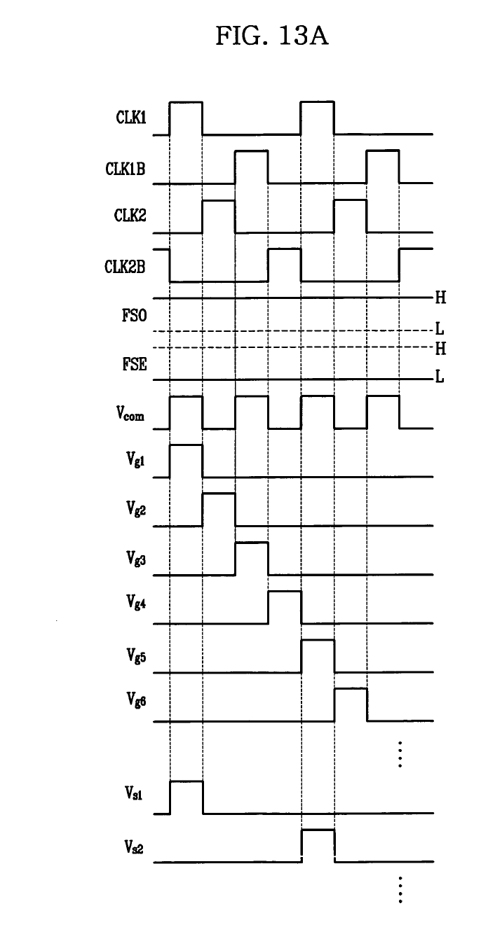

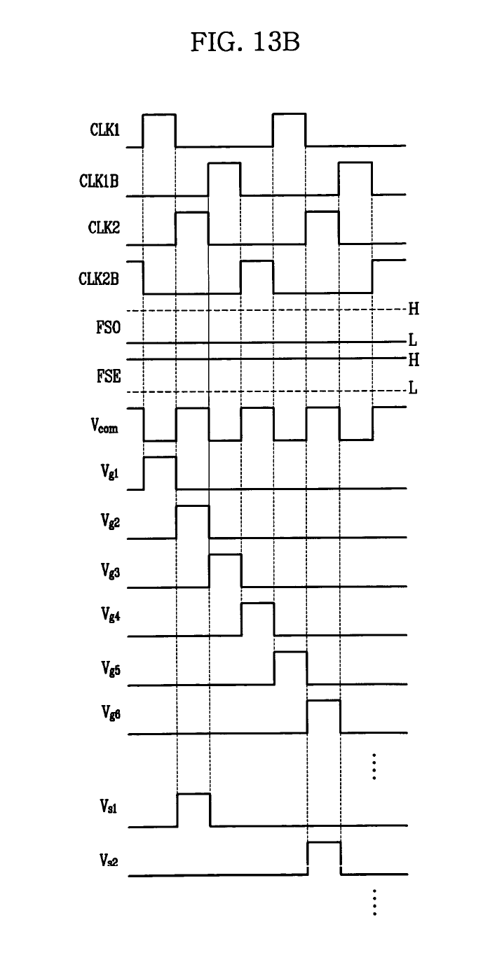

Next, an LC panel assembly, an image scanning driver, and a sensor scanning driver according to another embodiment of the present invention will be described with reference to FIGS. 12, 13A and 13B.

FIG. 12 is a block diagram of an LC panel assembly, an image scanning driver, and a sensor scanning driver according to another embodiment of the present invention, and FIGS. 13A and 13B are timing diagrams of input signals and output signals of the image scanning driver and the sensor scanning driver shown in FIG. 12 for odd frames and even frames, respectively.

Referring to FIG. 12, an LCD according to this embodiment includes an LC panel assembly 300, a pair of left and right image scanning drivers 400L and 400R, and a pair of left and right sensor scanning drivers 700L and 700R.

The LC panel assembly 300 includes a plurality of image scanning lines G₁-Gₙ, a plurality of sensor scanning lines S₁-Sₙ, and a plurality of pixels.

Every four sensor scanning lines S₁-Sₙ are grouped to be connected to each other to form a scanning line Sₜ₁-S_{tM}. The scanning lines Sₜ₁-S_{tM} are coupled to the left and the right sensor scanning drivers 700L and 700R and transmit sensor scanning signals Vs₁-Vs_{M} from the sensor scanning drivers 700L and 700R to the sensing units of the pixels. Here, M is equal to n/4, which means that the longitudinal resolution of the display units is four times the longitudinal resolution of the sensing units.

The left sensor scanning driver 700L includes a plurality of switching transistors QO. Each of the switching transistors QO has an input terminal coupled to a stage (STg₁, STg₅, . . . , STgₙ₋₃) of the left image scanning driver 400L, a control terminal connected to an odd frame signal FSO, and an output terminal connected to a scanning line Sₜ₁-S_{tM}.

In the odd frames, the left sensor scanning driver 700L is supplied with the odd frame signal FSO and outputs odd image scanning signals (Vg₁, Vg₅, . . . , Vgₙ₋₃) as the sensor scanning signals Vs₁-Vs_{M}.

The right sensor scanning driver 700R includes a plurality of switching transistors QE. Each of the switching transistors QE has an input terminal coupled to a stage (STg₂, STg₆, . . . , STgₙ₋₂) of the right image scanning driver 400R, a control terminal connected to an even frame signal FSE, and an output terminal coupled to a scanning line Sₜ₁-S_{tM}.

In even frames, the right sensor scanning driver 700R receives the even frame signal FSE and outputs even image scanning signals (Vg₂, Vg₆, . . . , Vgₙ₋₂) as sensor scanning signals Vs₁-Vs_{M}.

Referring to FIGS. 13A and 13B, the odd frame signal FSO has a high level H in odd frames and has a low level L in even frames. On the contrary, the odd frame signal FSO has a low level L in odd frames and has a high level H in even frames. The sensor scanning signals Vs₁-Vs_{M} becomes equal to the gate-on voltage Von every 4H according to the frame signals FSO and FSE only when the common voltage Vcom is in a high level.

In this configuration, four sensor scanning lines S₁-Sₙ are joined to overlap the sensor output signals, thereby further reducing the deviations of the characteristics of the photo sensing units SC and further increasing the signal-to-noise ratio.

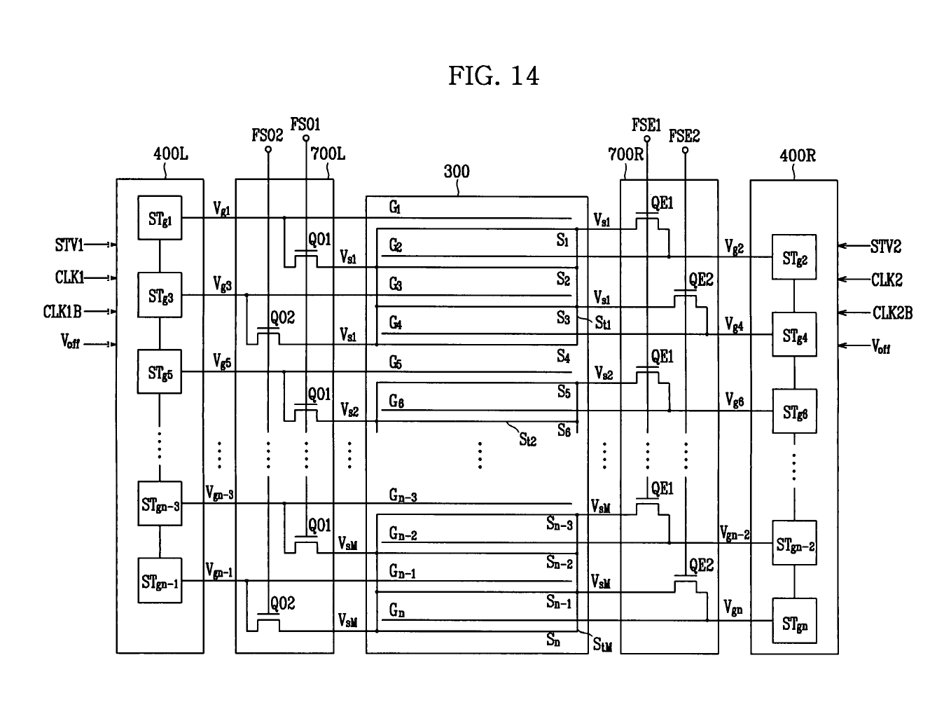

Next, an LC panel assembly, an image scanning driver, and a sensor scanning driver according to another embodiment of the present invention will be described with reference to FIG. 14.

FIG. 14 is a block diagram of an LC panel assembly, an image scanning driver, and a sensor scanning driver according to another embodiment of the present invention.

Referring to FIG. 14, an LCD according to this embodiment includes an LC panel assembly 300, a pair of left and right image scanning drivers 400L and 400R, and a pair of left and right sensor scanning drivers 700L and 700R.

The LC panel assembly 300 includes a plurality of image scanning lines G₁-Gₙ, a plurality of sensor scanning lines S₁-Sₙ, and a plurality of pixels.

Every four sensor scanning lines S₁-Sₙ are grouped to be connected to each other to form a scanning line Sₜ₁-S_{tM}. The scanning lines Sₜ₁-S_{tM} are coupled to the left and the right sensor scanning drivers 700L and 700R and transmit sensor scanning signals Vs₁-Vs_{M} from the sensor scanning drivers 700L and 700R to the sensing units of the pixels.

The left sensor scanning driver 700L includes a plurality of switching transistors QO1 and QO2. Each of the switching transistors QO1 has an input terminal coupled to a stage (STg₁, STg₅, . . . , STgₙ₋₃) of the left image scanning driver 400L, a control terminal connected to a frame signal FSO1, and an output terminal connected to a scanning line Sₜ₁-S_{tM}. Similarly, each of the switching transistors QO2 has an input terminal coupled to a stage (STg₃, STg₇, . . . , STgₙ₋₁) of the left image scanning driver 400L, a control terminal connected to a frame signal FSO2, and an output terminal connected to a scanning line Sₜ₁-S_{tM}.

The right sensor scanning driver 700R includes a plurality of switching transistors QE1 and QE2. Each of the switching transistors QE1 has an input terminal coupled to a stage (STg₂, STg₆, . . . , STgₙ₋₂) of the right image scanning driver 400R, a control terminal connected to a frame signal FSE1, and an output terminal coupled to a scanning line Sₜ₁-S_{tM}. Similarly, each of the switching transistors QE2 has an input terminal coupled to a stage (STg₄, STg₈, . . . , STgₙ) of the right image scanning driver 400R, a control terminal connected to a frame signal FSE2, and an output terminal coupled to a scanning line Sₜ₁-S_{tM}.

In the (4N-3)th frames (where N is an integer), the switching transistors QO1 receives the frame signal FSO1 and outputs image scanning signals (Vg₁, Vg₅, . . . , Vgₙ₋₃) as sensor scanning signals Vs₁-Vs_{M}. In the (4N-2)th frames, the switching transistors QE1 receives the frame signal FSE1 and outputs image scanning signals (Vg₂, Vg₆, . . . , Vgₙ₋₂) as sensor scanning signals Vs₁-Vs_{M}. In the (4N-1)th frames, the switching transistors QO2 receives the frame signal FSO2 and outputs image scanning signals (Vg₃, Vg₇, . . . , Vgₙ₋₁) as sensor scanning signals Vs₁-Vs_{M}. In the 4N-th frames, the switching transistors QE2 receives the frame signal FSE2 and outputs image scanning signals (Vg₄, Vg₈, . . . , Vgₙ) as sensor scanning signals Vs₁-Vs_{M}.

Although it is not shown, the frame signals FSO1, FSE1, FSO2 and FSE2 sequentially becomes a high level in a period of four frames. The sensor scanning signals Vs₁-Vs_{M} becomes equal to the gate-on voltage Von every 4H according to the frame signals FSO1, FSE1, FSO2 and FSE2 only when the common voltage Vcom is in a high level.

Like the above-described embodiment, four sensor scanning lines S₁-Sₙ are joined to overlap the sensor output signals, thereby further reducing the deviations of the characteristics of the photo sensing units SC and further increasing the signal-to-noise ratio.

The above-described embodiments can be also applied to other display devices such as organic light emitting diode display, field emission display, etc.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A display device comprising:
a display panel including a plurality of image scanning lines and a plurality of sensor scanning lines;
a plurality of display units coupled to the image scanning lines;
a plurality of photo sensing units coupled to the sensor scanning lines and outputting sensor output signals in response to an amount of external light;
an image scanning driver applying image scanning signals to the image scanning lines; and
an sensor scanning driver applying sensor scanning signals to the sensor scanning lines,
wherein the image scanning driver and the sensor scanning driver are disposed at the same side of the display panel.

2. The display device of claim 1, wherein the sensor scanning driver receives the image scanning signals from the image scanning driver and outputs the image scanning signals as the sensor scanning signals according to at least one frame signal.

3. The display device of claim 2, wherein the sensor scanning driver comprises a plurality of switching transistors connected between the image scanning driver and the sensor scanning lines.

4. The display device of claim 3, wherein the switching transistors comprise first and second switching transistors coupled to the same sensor scanning line and alternately turning on every frame.

5. The display device of claim 4, wherein the sensor scanning driver outputs odd image scanning signals from the image scanning driver as the sensor scanning signals in odd frames, and outputs even image scanning signals from the image scanning driver as the sensor scanning signals in even frames.

6. The display device of claim 3, wherein the switching transistors comprise first, second, third, and fourth switching transistors coupled to the same sensor scanning line and sequentially turning on in a period of four frames.

7. The display device of claim 1, wherein the image scanning driver comprises first and second image scanning circuits disposed at opposite sides of the display panel and alternately connected to the image scanning lines.

8. The display device of claim 7, wherein the sensor scanning driver comprises first and second sensor scanning circuits disposed at opposite sides of the display panel.

9. The display device of claim 8, wherein the sensor scanning lines comprise first sensor scanning lines coupled to the first sensor scanning circuit and second sensor scanning lines coupled to the second sensor scanning circuit, and the first and the second sensor scanning lines are alternately arranged on the display panel.

10. The display device of claim 8, wherein the first and the second sensor scanning circuits are coupled to the same scanning signal lines.

11. The display device of claim 10, wherein the first sensor scanning circuit outputs first image scanning signals from the first image scanning circuit and outputs the first image scanning signals as the sensor scanning signals according to the at least one frame signal, and the second sensor scanning circuit outputs second image scanning signals from the second image scanning circuit and outputs the second image scanning signals as the sensor scanning signals according to the at least one frame signal.

12. The display device of claim 11, wherein the first sensor scanning circuit comprises first switching transistors connected between the first image scanning circuit and the sensor scanning lines, and the second sensor scanning circuit comprises second switching transistors connected between the second image scanning circuit and the sensor scanning lines.

13. The display device of claim 12, wherein the first sensor scanning circuit outputs the first image scanning signals from the first image scanning circuit as the sensor scanning signals in odd frames, and outputs the second image scanning signals from the second image scanning circuit as the sensor scanning signals in even frames.

14. The display device of claim 1, wherein the sensor scanning signals are applied to the sensor scanning lines at different timings in different frames.

15. The display device of claim 14, wherein a common voltage applied to the display units swings between a high level and a low level, and the sensor output signals output when the common voltage is a predetermined one of the high level and the low level.

16. The display device of claim 15, wherein the display device performs frame inversion and row inversion.

17. The display device of claim 1, wherein the image scanning driver and the sensor scanning driver are integrated into the display panel.

18. The display device of claim 17, wherein the image scanning driver comprises a shift register including a plurality of stages.

19. The display device of claim 17, wherein the sensor scanning driver comprises a shift register including a plurality of stages.

20. The display device of claim 1, wherein at least two of the sensor scanning lines are connected to each other to be coupled to the sensor scanning driver.
